(19) United States
(12) Patent Application Publication
(10) Pub. No.: US 2023/0383022 A1
(43) Pub. Date: Nov. 30, 2023

(54) Concurrent Isomerization/Hydrogenation Of Unsaturated Polyalphaolefin In The Presence Of A High Activity Catalyst

(71) Applicant: ExxonMobil Chemical Patents Inc., Baytown, TX (US)

(72) Inventors: Mark H. Li, Sugar Land, TX (US); Renyuan Yu, Humble, TX (US); Patrick C. Chen, Houston, TX (US); Anatoly I. Kramer, Baytown, TX (US); Wenyih F. Lai, Bridgewater, NJ (US)

(21) Appl. No.: 18/245,961

(22) PCT Filed: Nov. 8, 2021
(86) PCT No.: PCT/US2021/072276

§ 371 Date: Mar. 20, 2023

Related U.S. Application Data
(60) Provisional application No. 63/114,714, filed on Nov. 17, 2020.

(51) Int. Cl. C08F 4/18; C08F 8/48; C08F 4/12

(52) U.S. Cl. CPC C08F 4/18; C08F 8/48; C08F 4/12

(57) ABSTRACT

Processes for making saturated isomerized polyalphaolefm by concurrently isomerizing and hydrogenating unsaturated polyalphaolefm in the presence of a high activity catalyst. Such processes can include contacting at least one unsaturated polyalphaolefm with a catalyst capable of both isomerizing and hydrogenating the polyalphaolefm, wherein the catalyst includes a zeolite or mesoporous material, the zeolite having a silica to alumina mole ratio of from about 5 to about 100 and an alpha value of from about 10 to about 1,000, and the mesoporous material having a collidine uptake of from about 100 μμmoles/g to about 500 μmoles/g, wherein a Group VIB to VIIIB metal is incorporated in the catalyst at a concentration of from about 0.01 wt % to about 60.00 wt %, and wherein the zeolite is selected from the group consisting of ZSM-48, ZSM-23, ZSM-12, ZSM-35, ZSM-11, ZSM-57, Beta zeolite, Mordenite zeolite, USY zeolite, zeolite having a MWW framework, and combinations thereof.

### PRIORITY

This application claims priority to and the benefit of U.S. Provisional Application No. 63/114,714, filed Nov. 17, 2020, the disclosure of which is incorporated herein by reference in its entirety.

### FIELD

Embodiments of the present invention generally relate to processes for upgrading polyalphaolefin. More particularly, such embodiments relate to processes for making saturated isomerized polyalphaolefin by concurrently isomerizing and hydrogenating unsaturated polyalphaolefin in the presence of a catalyst exhibiting high activity.

### BACKGROUND

The demand for high quality base stocks for use in engine oils and other lubricants has increased due to heightened environmental concerns. Polyalphaolefins (PAOs) make up one class of synthetic hydrocarbon oil that has achieved importance as a base stock in the lubricant market. PAO is typically produced by the polymerization of unsaturated alpha olefins, such as 1-hexene, 1-octene, 1-decene, and 1-dodecene, or mixtures thereof. Polymers of lower olefins such as ethylene and propylene can also be used, including copolymers of ethylene with higher olefins, as described in U.S. Pat. No. 4,956,122.

Intermediate PAO produced in this manner is unsaturated and thus could be subjected to separate steps of isomerization and hydrogenation to produce saturated isomerized PAO having improved properties. Such improved properties include low volatility, low friction, low pour point, high temperature stability, low CCS viscosity which can improve cold engine start-up, and oxidation resistance which can prevent the buildup of sludge when used as a base stock lubricant in internal combustion engines.

The isomerization of the unsaturated PAO is typically performed in the presence of an acid catalyst in a hydrogen-free reactor while the subsequent hydrogenation of the isomerized PAO is performed in a separate reactor containing hydrogen and a metallic hydrogenation catalyst. As such, the cost of carrying out both steps of isomerization and hydrogenation separately can be relatively high. Another drawback of upgrading the unsaturated PAO in this manner is the formation of lighter olefins, such as C₄ to C₂₀ olefins that are a cracking by-product of the isomerization step. The presence of such lighter olefins can undesirably affect the properties of the final PAO product and thus are often removed via, e.g., distillation, from the PAO product, which can increase the cost of producing the PAO product even more.

A need therefore exists for a way of reducing the costs of isomerizing and hydrogenating unsaturated PAO. It is also desirable to minimize the amount of cracking by-product that forms during isomerization. to improve product yield.

### SUMMARY

Processes for making saturated isomerized polyalphaolefin by concurrently isomerizing and hydrogenating unsaturated polyalphaolefin in the presence of a high activity catalyst are provided. In one or more embodiments, a process for making a saturated isomerized polyalphaolefin can include contacting at least one unsaturated polyalphaolefin with a catalyst capable of both isomerizing and hydrogenating the at least one unsaturated polyalphaolefin to form at least one saturated isomerized polyalphaolefin, wherein the catalyst includes a zeolite or a mesoporous material, the zeolite having a silica to alumina mole ratio of from about 5 to about 100 and an alpha value of from about 10 to about 1,000, and the mesoporous material having a collidine uptake of from about 100 μmoles/g to about 500 moles/g, wherein a Group VIB to VIIIB metal is incorporated in the catalyst at a concentration of from about 0.01 wt % to about 60.00 wt %, based on a total weight of the catalyst, and wherein the zeolite is selected from the group consisting of ZSM-48, ZSM-23, ZSM-12, ZSM-35, ZSM-11, ZSM-57, Beta zeolite, Mordenite zeolite, USY zeolite, zeolite having an MWW framework, and combinations thereof.

In one or more embodiments, a process for making a saturated isomerized polyalphaolefin can include: contacting at least one unsaturated polyalphaolefin with a catalyst capable of both isomerizing and hydrogenating the at least one unsaturated polyalphaolefin to make at least one saturated isomerized polyalphaolefin, wherein the catalyst comprises a zeolite selected from the group consisting of ZSM-48, ZSM-23, and combinations thereof, the zeolite having a silica to alumina mole ratio of from about 20 to about 100 and an alpha value of from about 50 to about 600, and wherein a Group VIB to VIIIB metal is incorporated in the catalyst at a concentration of from about 0.01 wt % to about 60.00 wt %, based on a total weight of the catalyst.

### DETAILED DESCRIPTION

It is to be understood that the following disclosure describes several exemplary embodiments for implementing different features, structures, and/or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments. This repetition is for the purpose of simplicity and clarity and does not in itself dictate a relationship between the various exemplary embodiments. Moreover, the exemplary embodiments presented below can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

In the following discussion and in the claims, the terms “including” and “comprising” are used in an open-ended fashion, and thus should be interpreted to mean “including, but not limited to.” The phrase “consisting essentially of” means that the described/claimed composition does not include any other components that will materially alter its properties by any more than 5% of that property, and in any case does not include any other component to a level greater than 3 mass %.

The term “or” is intended to encompass both exclusive and inclusive cases, i.e., “A or B” is intended to be synonymous with “at least one of A and B,” unless otherwise expressly specified herein.

The indefinite articles “a” and “an” refer to both singular forms (i.e., “one”) and plural referents (i.e., one or more) unless the context clearly dictates otherwise. For example, embodiments using “an olefin” include embodiments where one, two, or more olefins are used, unless specified to the contrary or the context clearly indicates that only one olefin is used.

The term “wt %” means percentage by weight, “vol %” means percentage by volume, “mol %” means percentage by mole, “ppm” means parts per million, and “ppm wt” and “wppm” are used interchangeably to mean parts per million on a weight basis. All concentrations herein, unless otherwise stated, are expressed on the basis of the total amount of the composition in question.

The term “hydrocarbon” refers to a class of compounds containing hydrogen bound to carbon, and encompasses (i) saturated hydrocarbon compounds; (ii) unsaturated hydrocarbon compounds; and (iii) mixtures of hydrocarbon compounds (saturated and/or unsaturated), including mixtures of hydrocarbon compounds having different values of n.

As used herein, a “carbon number” refers to the number of carbon atoms in a hydrocarbon. Likewise, a “Cx” hydrocarbon is one having x carbon atoms (i.e., carbon number of x), and a “Cx-Cy” or “Cx-y” hydrocarbon is one having from x to y carbon atoms.

The term “alkane” refers to non-aromatic saturated hydrocarbons with the general formula CₙH₍₂ₙ₊₂₎, where n is 1 or greater. An alkane may be straight chained or branched. Examples of alkanes include methane, ethane, propane, butane, pentane, hexane, heptane and octane. “Alkane” is intended to embrace all structural isomeric forms of an alkane. For example, butane encompasses n-butane and isobutane; pentane encompasses n-pentane, isopentane and neopentane.

The term “olefin,” and “alkene,” are used interchangeably to refer to a branched or unbranched unsaturated hydrocarbon having one or more carbon-carbon double bonds. A simple olefin comprises the general formula CₙH₂n, where n is 2 or greater. Examples of olefins include ethylene, propylene, butylene, pentene, hexene and heptene. “Olefin” is intended to embrace all structural isomeric forms of an olefin. For example, butylene encompasses but-1-ene, (Z)-but-2-ene, etc.

The terms “polymer” and “oligomer” are used interchangeably to refer to any two or more of the same or different repeating units/mer units or units. The term “homopolymer” refers to a polymer having units that are the same. The term “copolymer” refers to a polymer having two or more units that are different from each other, and includes terpolymers and the like. The term “terpolymer” refers to a polymer having three units that are different from each other. The term “different” as it refers to units indicates that the units differ from each other by at least one atom or are different isomerically. Likewise, the definition of polymer, as used herein, includes homopolymers, copolymers, and the like. By way of example, when a copolymer is said to have a “propylene” content of 10 wt % to 30 wt %, it is understood that the repeating unit/mer unit or simply unit in the copolymer is derived from propylene in the polymerization reaction and the derived units are present at 10 wt % to 30 wt %, based on a weight of the copolymer.

The term “alphaolefin” refers to any linear or branched compound of carbon and hydrogen having at least one double bond between the a and p carbon atoms. For purposes of this specification and the claims appended thereto, when a polymer or copolymer is referred to as including an alphaolefin, e.g., polyalphaolefin, the alphaolefin present in such polymer or copolymer is the polymerized form of the alphaolefin.

The term “reactor” refers to any vessel(s) in which a chemical reaction occurs. Reactor includes both distinct reactors, as well as reaction zones within a single reactor apparatus and, as applicable, reactions zones across multiple reactors. For example, a single reactor may have multiple reaction zones.

Nomenclature of elements and groups thereof used herein are pursuant to the Periodic Table used by the International Union of Pure and Applied Chemistry after 1988. An example of the Periodic Table is shown in the inner page of the front cover of Advanced Inorganic Chemistry, 6th Edition, by F. Albert Cotton et al. (John Wiley & Sons, Inc., 1999).

A detailed description will now be provided. Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with publicly available information and technology.

A process for making saturated isomerized polyalphaolefin is disclosed that can include contacting at least one unsaturated polyalphaolefin (PAO) with a catalyst capable of both isomerizing and hydrogenating the at least one unsaturated PAO to make at least one saturated isomerized PAO. The catalyst can include a zeolite or a mesoporous material combined with a binder, and a group VIB to VIIIB metal can be incorporated in the catalyst at a concentration of from about 0.01 wt % to about 60.00 wt %, based on the total weight of the catalyst. As used herein, the term “mesoporous material” refers to a to porous material having a maximum perpendicular cross-section pore dimension of from about 20 Å to about 200 Å. Zeolites having a relatively low silica to alumina (SiO₂/Al₂O₃) mole ratio of from about 5 to about 100 and an alpha value of from about 2 to about 600 can be used to produce a high activity catalyst. Mesoporous materials having a collidine uptake of from about 100 μmoles/g to about 500 μmoles/g can also be employed in the catalyst to yield a high activity catalyst.

The “alpha value” is a measure of the cracking activity of a catalyst, and the test for determining the alpha value disclosed herein is described in U.S. Pat. No. 3,354,078 and in the Journal of Catalysis, Vol. 4, p. 527 (1965); Vol. 6, p. 278 (1966) and Vol. 61, p. 395 (1980), each of which is incorporated by reference herein. The test is performed at a constant temperature of 538° C. and a variable flow rate as described in detail in the Journal of Catalysis, Vol. 61, p. 395 (1980).

The “collidine uptake” of a catalyst is measured on a TA Instruments Q5000 model TGA machine (available from TA Instruments, of New Castle, Delaware) with a modified gas and vapor delivery system in accordance to the following procedure. A catalyst sample of 10 to 50 mg is first dried under flowing N₂ (90 cm³/min) at 200° C. for 60 minutes or until a stable weight is achieved. Then a N₂ stream (90 cm³/min) flowing through a reservoir of collidine (2,4,6-trimethylpyridine, held at 35° C.) and a condenser (held at 26° C.) is delivered to the sample. The partial pressure of collidine is set by the temperature of the condenser and the N₂ flow rate. The sparged collidine is delivered over the sample for 60 minutes, followed by 60 minutes of stripping with flowing N₂. The increase in sample weight indicates adsorption of collidine. Uptake is reported in μmol (i.e., micromole) collidine per gram of catalyst.

The catalyst disclosed herein advantageously has a high activity and can be used for both isomerization and hydrogenation of unsaturated PAO to produce saturated isomerized PAO in a single reactor. Consequently, the cost of upgrading the unsaturated PAO can be lowered significantly with the use of such catalyst. In addition, the high activity of the catalyst can allow for the isomerization/hydrogenation to be conducted under mild process conditions, particularly at low temperature, and thus results in improved selectivity to the desired PAO product and lower generation of cracking by-product. It is believed that less than about 3 wt % of the cracking by-product, i.e., PAO with C₄ to C₂₀ olefin monomer units, is formed. Also, the use of a high activity catalyst can desirably result in the final PAO product having a lower pour point. It is believed that the pour point can be reduced by about 5 to 15° C. via the use of the catalysts disclosed herein. The measurement of pour point of the isomerized/hydrogenated PAO product was done via industry standard ASTM D5950 (“Automatic Tilt Method”) to measure pour points of all LoVis PAO products. This test method is devised to measure pour point of petroleum products from −57° C. to +51° C. Even so, this method was successfully used for measurement of pour points down to −90° C. that was shown to successfully correlate with manual pour point method D97. In the analyzer, a test jar containing the fluid is allowed to equilibrate at a temperature and then it is tilted from a vertical position toward a horizontal position to induce movement of the fluid. Tilting of the test jar is done automatically at 3° C. cooling intervals until the “no-flow” point occurs. The preceding temperature where fluid movement was detected is considered the “pour point”. In practice the “no-flow” condition occurs when the test flask is tilted and held in a horizontal position for 5 seconds without detection of specimen movement.

### Isomerization and Hydrogenation Process

Unsaturated PAO can be fed to a reactor containing the catalyst disclosed herein, along with a sufficient amount of H₂, under conditions effective to concurrently isomerize and hydrogenate the unsaturated PAO and form saturated isomerized PAO. As disclosed herein, the term “concurrently” is taken to mean that the isomerization and hydrogenation reactions both occur in the presence of a single type of catalyst. A wide range of reactor configuration can be used, including fixed bed and fluidized bed, preferably fixed bed. The isomerization reaction can result in a movement of double bonds in the unsaturated PAO and skeletal isomerization. Skeletal isomerization results in the formation of branches. Depending on the catalyst system used and the process conditions, there can be a formation of up to about 20 branches per molecule. Formation of these branches can contribute to the lowering of the pour point of the PAO. The hydrogenation reaction can cause the saturation or removal of the double bonds via the addition of pairs of H₂ to the PAO. The isomerization of the PAO is indicated by a drop in pour point of the PAO, and the hydrogenation of the PAO is indicated by a decrease in bromine number of the PAO. The bromine number is a measurement of the unsaturated double bonds in the PAO. Bromine number can be measured in g Br per 100 g of sample of finished PAO product. When the final saturated isomerized PAO product is a low viscosity PAO, it can have: a pour point of greater than about −99° C. and less than about −45° C. or even less than about −90° C.; and a bromine number of less than about 0.5 g Br/100 g sample. Such low bromine number indicates near complete hydrogenation of the unsaturated PAO fed to the reactor. Alternatively, when the final saturated isomerized PAO product is a low viscosity PAO, it can have: a pour point of greater than about −51° C. and less than about −30° C.; and a bromine number of less than about 2.0 g Br/100 g sample.

Typically, an excess amount of H₂ is employed for the hydrogenation reaction. The amount of H₂ can range from about 0.1 to about 3.0 wt %, preferably from about 0.2 to about 2.0 wt %, and more preferably from about 0.5 to about 1.5 wt %, based on the total weight of the PAO feed. The pressure of the H₂ being fed to the reactor can range from about 689 about 6,895 kPa.

The isomerization/hydrogenation process is typically conducted under conditions suitable to maintain the reaction medium in the liquid phase. Preferably, the reactor is operated at mild process conditions, particularly at low temperature. The reactor temperature can range from about 150° C. to about 500° C., preferably from about 180° C. to about 400° C., and more preferably from about 220° C. to about 300° C. The reactor pressure can range from about 345 kPa absolute to about 6,895 kPa absolute, preferably from about 689 kPa absolute to about 5,171 kPa absolute, and more preferably from about 1,034 kPa absolute to about 6,895 kPa absolute. The PAO feed can be supplied to the reactor at a weight hourly space velocity (WHSV) ranging from about 0.1 h⁻¹ to about 10.0 h⁻¹. Preferably, the WHSV range (as tested) is from about 3.0 to about 4.5 h⁻¹. Hydrogen flow is set at about 1 to 10 mol equivalence with respect to the liquid feed flow rate.

Preferably, the isomerization reaction is highly selective to the desired saturated isomerized PAO product, e.g., saturated isomerized PAO having C₂₀₊ olefin monomer units, and exhibits minimal side reactions such as oligomerization and cracking (to form PAO with C₄ to C₂₀ olefin monomer units).

### Isomerization and Hydrogenation Catalyst

The isomerization/hydrogenation catalyst can include a mixture of a zeolite or a mesoporous material and a binder with a Group VIB to VIIIB metal incorporated therein. The zeolite content or the mesoporous material content in the catalyst can range from about 10 wt % to about 100 wt %, preferably from about 20 wt % to about 90 wt %, and more preferably from about 50 wt % to about 65 wt %. The catalyst can contain a balance of binder ranging from about 0 wt % to about 90 wt %, preferably from about 10 wt % to about 80 wt %, and more preferably from about 35 wt % to about 50 wt %. The foregoing weight percentages are based on the total weight of the catalyst.

Examples of Group VIB to VIIIB metals include Pt, Pd, or a combination thereof. In this case, the metal content can range from about 0.01 wt % to about 10.00 wt %, preferably from about 0.05 wt % to about 5.00 wt %, and more preferably from about 0.10 wt % to about 1.00 wt %, based on the total weight of the catalyst. Other examples of Group VIB to VIIIB metals include Co, Ni, W, Mo, or combinations thereof. In this case, the metal content can range from about 0.05 wt % to about 60.00 wt %, preferably from about 0.50 wt % to about 30.00 wt %, and more preferably from about 1.00 wt % to about 20.00 wt %, based on the total weight of the catalyst. The Group VIB to VIIIB metal also could include any combination of Pt, Pd, Co, Ni, W, or Mo. The Group VIB to VIIIB metal can be incorporated in the catalyst by mixing it with the zeolite or mesoporous material and the binder or by impregnating it on the catalyst.

In embodiments in which the catalyst is zeolite, the zeolite can have an alpha value ranging from about 2 to about 600, from about 20 to about 400, or from about 60 to about 300. Since the alpha value can indicate the amount of cracking of the catalyst, a lower alpha value is preferred to inhibit the formation of lower olefins. The zeolite can be or can include a microporous crystalline material (i.e., a molecular sieve), preferably a microporous crystalline aluminosilicate. Preferred microporous crystalline aluminosilicates are those having a ten or twelve membered ring pore opening, channel, or pocket. As used herein, the term “microporous material” refers to a material containing pores with diameters less than about 20 Å.

In one or more embodiments, suitable microporous crystalline aluminosilicates are those having a medium pore size of from about 4.5 to about 5.5 Angstroms (Å), preferably about 5.0 to about 5.5 A, and having a Constraint Index of from about 2 to about 12 (as defined in U.S. Pat. No. 4,016,218, which is incorporated by reference herein), including ZSM-23, ZSM-35, ZSM-11, ZSM-12, ZSM-48, ZSM-57, and combinations thereof. Preferred microporous crystalline aluminosilicates are ZSM-23, ZSM-48, and combinations thereof, which have a silica to alumina mole ratio of about 20 to about 100. ZSM-23 is described in U.S. Pat. No. 4,076,842. ZSM-35 is described in U.S. Pat. No. 4,016,245. The composition and method of manufacture of ZSM-11 are described in, for example, U.S. Pat. No. 3,709,979. The composition and method of manufacture of ZSM-12 are described in, for example, U.S. Pat. No. 4,556,477 and WO 93/25475. The composition and method of manufacture of ZSM-48 are described in, for example, U.S. Pat. No. 4,375,573. The composition and method of manufacture of ZSM-57 are described in, for example, U.S. Pat. No. 4,973,870. The entire contents of all of the above patents are incorporated by reference herein.

In one or more embodiments, suitable microporous crystalline aluminosilicates are those having a larger pore size of from about 5.8 to about 7.5 Å and a Constraint Index of less than about 2 (as defined in U.S. Pat. No. 4,016,218), including molecular sieves having an MWW framework, Beta zeolite, Mordenite, Unstable Y (USY) zeolite, and combinations thereof.

The structure of the MWW framework, as determined by the Structure Commission of the International Zeolite Association, can be found at www.iza-structure.org. Examples of suitable molecular sieves having an MWW framework include molecular sieves of the MCM-22 family. The term “MCM-22 family” refers to one or more of the following types of molecular sieves:
molecular sieves made from a common first degree crystalline building block unit cell, which unit cell has the MWW framework topology;
molecular sieves made from a common second degree building block, being a 2-dimensional tiling of such MWW framework topology unit cells, forming a monolayer of one unit cell thickness, preferably one c-unit cell thickness;
molecular sieves made from common second degree building blocks, being layers of one or more than one unit cell thickness, wherein the layer of more than one unit cell thickness is made from stacking, packing, or binding at least two monolayers of one unit cell thickness. The stacking of such second degree building blocks can be in a regular fashion, an irregular fashion, a random fashion, or any combination thereof, and
molecular sieves made by any regular or random 2-dimensional or 3-dimensional combination of unit cells having the MWW framework topology,
where the term “unit cell” refers to a spatial arrangement of atoms which if tiled in three-dimensional space describes the crystal structure. Such crystal structures are discussed in the “Atlas of Zeolite Framework Types”, Fifth edition, 2001, the entire content of which is incorporated by reference herein

Molecular sieves of the MCM-22 family generally have an X-ray diffraction pattern including d-spacing maxima at 12.4±0.25, 6.9±0.15, 3.57±0.07 and 3.42±0.07 Å. The X-ray diffraction data used to characterize the material are obtained by standard techniques using the K-alpha doublet of copper as the incident radiation and a diffractometer equipped with a scintillation counter and associated computer as the collection system. Molecular sieves of the MCM-22 family include MCM-22 (described in U.S. Pat. Nos. 4,954,325, 7,883,686, and 8,021,643), PSH-3 (described in U.S. Pat. No. 4,439,409), SSZ-25 (described in U.S. Pat. No. 4,826,667), ERB-1 (described in European PatentNo. 0293032), ITQ-1 (described in U.S. Pat. No. 6,077,498), ITQ-2 (described in International Publication No. WO97/17290), MCM-36 (described in U.S. Pat. No. 5,250,277), MCM-49 (described in U.S. Pat. No. 5,236,575), MCM-56 (described in U.S. Pat. No. 5,362,697), and combinations thereof. MCM-49 is a preferred molecular sieve of the MCM-22 family.

Preferred zeolites are highly acidic and therefore highly active. The silica to alumina mole ratio of the zeolites are selected as follows to help achieve such high activity. The ZSM-12, the Beta zeolite, the Mordenite, the USY zeolite, and the zeolites having an MWW framework, e.g., MCM-49, preferably have a silica to alumina mole ratio of from about 10 to about 60, more preferably from about 16 to about 30. The ZSM-23 preferably has a silica to alumina mole ratio of from about 30 to about 60, more preferably from about 35 to about 45. The ZSM-48 preferably has a silica to alumina mole ratio of from about 50 to about 100, more preferably from about 60 to about 80. The ZSM-35 preferably has a silica to alumina mole ratio of from about 20 to about 60, more preferably from about 20 to about 30. The ZSM-11 preferably has a silica to alumina mole ratio of from about 20 to about 60, more preferably from about 20 to about 40. Also, the ZSM-57 preferably has a silica to alumina mole ratio of from about 30 to about 60, more preferably from about 40 to about 50.

In embodiments in which the catalyst is a mesoporous material mixed with a binder, the mesoporous material has a high surface acidity, as indicated by its high collidine uptake. In particular, the mesoporous material can have a collidine uptake ranging from about 100 to about 500 μmoles/g, more preferably from about 150 to about 500 μmoles/g.

In one or more embodiments, the mesoporous material can include a crystalline phase material. In such aspects, the mesoporous material can be layered or non-layered, wherein “non-layered” is herein defined as non-lamellar. In layered (i.e., lamellar) materials, the interatomic bonding in two directions of the crystalline lattice is substantially different from that in the third direction, resulting in a structure that contains cohesive units resembling sheets. Usually, the bonding between the atoms within these sheets is highly covalent, while adjacent layers are held together by ionic forces or van der Waals interactions. These latter forces can frequently be neutralized by relatively modest chemical means, while the bonding between atoms within the layers remains intact and unaffected. Preferred mesoporous materials having a crystalline framework exhibit an X-ray diffraction pattern, after calcination, with at least one peak at a position greater than about 18 Angstrom units, d-spacing with a relative intensity of 100, and have a benzene adsorption capacity of greater than about 15 grams benzene per 100 grams of the anhydrous material at 50 torr (6.7 kPa) and 25° C. A preferred example of such mesoporous material is MCM-41, which has a hexagonal arrangement of uniformly-sized pores and is described in U.S. Pat. Nos. 5,098,684 and 5,057,296, the entire contents of which are incorporated by reference herein. Preferably, the MCM-41 has a pore size of about 20 to 60 Å and a silica to alumina mole ratio of about 15 to 50.

In one or more embodiments, the mesoporous material can include an amorphous phase material, where the term “amorphous phase material” refers to a material that is not highly crystalline. Examples of suitable mesoporous materials include amorphous silica, amorphous alumina, and amorphous mixed metal oxides such as amorphous silica-alumina and amorphous silica-titania. Particularly suitable mesoporous materials are amorphous silica-alumina hydrates commercially available from Sasol Performance Chemicals GmbH under the tradename Siral™. The amorphous material can optionally include a dopant to increase its acidity. Examples of suitable dopants include zirconium, magnesium, thorium, beryllium, titanium, sulfate (SO₄), and combinations thereof, with sulfate being preferred Typically, the dopant can be present in an amount ranging from about 0.1 wt % to about 20 wt % based on the total weight of the catalyst, such as from about 1 wt % to about 10 wt %. The dopant can be added via any method known in the art, preferably by impregnating the amorphous material with a solution containing the dopant. For example, convenient sources of zirconium include zirconyl chloride hydrate and zirconium acetate solutions, while a convenient source of sulfate is ammonium sulfate solution.

As mentioned previously, the catalyst can include a binder or matrix material mixed with the zeolite or the mesoporous material. Examples of suitable binders include clay and/or inorganic oxides that are resistant to the temperatures and other conditions employed in the isomerization/hydrogenation process. Naturally occurring clays which can be used as a binder include those of the montmorillonite and kaolin families, which families include the subbentonites and the kaolins commonly known as Dixie, McNamee, Georgia, and Florida clays or others in which the main mineral constituent is halloysite, kaolinite, dickite, nacrite, or anauxite. Such clays can be used in the raw state as originally mined or initially subjected to calcination, acid treatment, or chemical modification. Suitable inorganic oxide binders can be either naturally occurring or in the form of gelatinous precipitates or gels, including mixtures of silica and metal oxides. Specific examples of suitable inorganic oxide binders include silica, alumina, zirconia, titania, silica-alumina, silica-magnesia, silica-zirconia, silica-thoria, silica-beryllia, silica-titania as well as ternary compositions such as silica-alumina-thoria, silica-alumina-zirconia, silica-alumina-magnesia and silica-magnesia-zirconia.

### Unsaturated PAO Feed

The unsaturated PAO feed can include one or more Group IV base oils, as defined by the American Petroleum Institute (API Publication 1509; www.API.org). Group IV base oils are synthetic polymerized olefins. The unsaturated PAO feed can be or can include low viscosity PAOs having a kinematic viscosity of from about 2 to about 10 cSt at 100° C., according to ASTM D-445 (100° C., D-445). Alternatively, the unsaturated PAO feed can be or can include high viscosity PAOs having a kinematic viscosity of from about 20 to about 300 cSt (100° C., D-445). The PAOs are typically comprised of relatively low molecular weight hydrogenated polymers or oligomers of alphaolefins, including C₄ to about C₂₀ alphaolefins such as 1-hexene, 1-octene, 1-decene, 1-dodecene, and the like. However, the dimers of higher olefins in the range of C₁₄ to C₁₈ can be used to provide low viscosity PAOs of low volatility. Depending on the viscosity grade and the starting oligomer, the low viscosity PAOs can also be predominantly trimers, tetramers, and pentamers of the starting olefins, with minor amounts of the higher oligomers.

Unsaturated PAOs can be conveniently made by the polymerization of an alphaolefin in the presence of a polymerization catalyst such as a Lewis acid catalyst, e.g, BF₃ or AlCl₃, or a Friedel-Crafts catalyst, e.g., aluminum trichloride, boron trifluoride or complexes of boron trifluoride with water, alcohols such as ethanol, propanol or butanol, and carboxylic acids or esters such as ethyl acetate or ethyl propionate. Suitable methods for making PAOs are disclosed in U.S. Pat. Nos. 4,149,178 and 3,382,291, the relevant portions of which are incorporated by reference herein. Other descriptions of PAO synthesis can be found in the following U.S. Pat. Nos. 3,742,082; 3,769,363; 3,876,720; 4,239,930; 4,367,352; 4,413,156; 4,434,408; 4,910,355; 4,956,122; and 5,068,487. The dimers of C₁₄ to C₁₈ olefins are described in U.S. Pat. No. 4,218,330.

Alternatively or additionally, the polymerization catalyst can include one or more non-metallocene Ziegler-Natta catalysts. Alternatively or additionally, the catalyst system can include a metal oxide supported on an inert material, e.g., chromium oxide supported on silica. Such catalyst systems and uses thereof in the process for making PAOs are disclosed in the following U.S. Pat. Nos. 4,827,073; 4,827,064; 4,967,032; 4,926,004; and 4,914,254, the relevant portions of which are incorporated by reference herein

The polymerization catalyst can alternatively or additionally include one or more metallocene catalysts. Metallocene-catalyzed PAO (mPAO) can be a homopolymer made from a single alphaolefin feed or can be a copolymer made from two or more different alphaolefins, each by employing a suitable metallocene catalyst system. Suitable metallocene catalysts can be or can include one or more simple metallocenes, substituted metallocenes, or bridged metallocene catalysts activated or promoted by, for instance, methylaluminoxane (MAO) or a non-coordinating anion, such as N,N-dimethylanilinium tetrakis(perfluorophenyl)borate or other equivalent non-coordinating anions. mPAO and methods for producing mPAO employing metallocene catalysis are described in WO 2007/011832 and U.S. Patent Application No. 2009/0036725, the relevant portions of which are incorporated by reference herein.

Homopolymer mPAO compositions can be made from single alphaolefins chosen from alphaolefins in the C₄ to C₂₀ range. The homopolymers can be isotactic, atactic, syndiotactic, or of any other appropriate tacticity. The tacticity can be tailored by the choices of polymerization catalyst, polymerization reaction conditions, hydrogenation conditions, or combinations thereof.

Copolymer mPAO compositions can be made from at least two alphaolefins of C₂ to C₃₀ range, and typically have monomers randomly distributed in the finished copolymers. Advantageously, ethylene and propylene, if present in the feed, can be present in the amount of less than 50 mass % individually or preferably less than 50 mass % combined. The copolymers can be isotactic, atactic, syndiotactic or of any other appropriate tacticity.

Copolymer mPAO compositions can also be made from mixed feed linear alpha olefins (LAOs) having from 2 to 26 different linear alphaolefins selected from C₂ to C₃₀ linear alphaolefins. Such mixed feed LAO can be obtained from an ethylene growth process using an aluminum catalyst or a metallocene catalyst. The growth olefins can be mostly C₆ to C₁₈ LAO. LAOs from other processes can also be used.

The PAO feed can be pretreated prior to isomerization/hydrogenation to remove moisture, oxygenates, nitrates, and other impurities that could deactivate the isomerization/hydrogenation catalyst. Typically, the pretreatment is performed by passing the feed through a guard bed that contains a molecular sieve. Typically, the pretreated feed contains less than about 50 wppm water based on the weight of the feed, more preferably less than about 25 wppm.

### EXAMPLES

The foregoing discussion can be further described with reference to the following non-limiting examples.

Twelve different isomerization/hydrogenation catalysts (Examples 1-9) were prepared as described below. When small crystals are used, the crystal size is less than about 0.1 micrometer (micron).

### Example 1: Pt Coated H-Formed ZSM-48 Crystals

High activity small ZSM-48 crystals with a silica/alumina mole ratio of about 70 were synthesized according to the methods described in the U.S. Pat. No. 7,482,300, which is incorporated by reference herein. The XRD pattern of the as-synthesized material showed the typical phase topology of ZSM-48. The SEM of the as-synthesized material showed that the material was composed of agglomerates of small crystals. The resulting dried crystals were calcined in nitrogen for about 3 hours at about 1000° F., ammonium exchanged with ammonium nitrate having a Normality of about 1 N, and calcined in air for about 6 hours at about 1,000° F. The finished H-formed crystals had an alpha value of about 100, hexane sorption of 47 mg/g, and surface area of 296 m2/g. The calcined material was then impregnated with platinum (0.6 wt % Pt loading) via incipient wetness using tetraammineplatinum nitrate followed by drying at 250° F. (120° C.) and calcination in full air at 680° F. (360° C.) for 3 hours.

### Example 2: Pt Coated H-Formed ZSM-23 Crystals

High activity small ZSM-23 crystals with a silica/alumina mole ratio of about 40 were prepared according to the methods described in the U.S. Pat. No. 8,500,991, which is incorporated by reference herein. The XRD pattern of the as-synthesized material showed the typical phase topology of ZSM-23. The SEM of the as-synthesized material shows that the material was composed of agglomerates of small crystals. The as-synthesized crystals were converted into the hydrogen form by three ion exchanges with ammonium nitrate solution at room temperature, followed by drying at 250° F. (120° C.) and calcination at 1,000° F. (540° C.) for 6 hours. The resulting ZSM-23 crystals had an alpha value of about 520, hexane sorption of about 50 mg/g, and surface area of 287 m2/g. The calcined material was then impregnated with platinum (0.6 wt % Pt loading) via incipient wetness using tetraammineplatinum nitrate followed by drying at 250° F. (120° C.) and calcination in full air at 680° F. (360° C.) for 3 hours.

### Example 3: Pt Coated ZSM-48/Alumina Extrudate

65 parts by weight (basis: calcined 538° C.) of ZSM-48 crystal (having a silica/alumina mole ratio of about 70) synthesized according to U.S. Pat. No. 7,482,300 were mixed with 35 parts by weight (basis: calcined 538° C.) of pseudoboehmite alumina (Versal™ 300 commercially available from UOP Honeywell) in a muller. The mixture of ZSM-48, alumina, and water was extruded to make 1/16″ Quadrulobe extrudate and then dried at 121° C. overnight. The dried extrudate was calcined in nitrogen (N₂) at 538° C. to decompose and remove the organic template. The N₂-calcined extrudate was humidified with saturated air and exchanged with 1 N ammonium nitrate to remove sodium (spec: <500 ppm Na). After the ammonium nitrate exchange, the extrudate was washed with deionized water to remove residual nitrate ions prior to drying. The ammonium exchanged extrudate was dried at 121° C. overnight and calcined in air at 538° C. The H-formed catalyst showed an alpha value of 68, surface area of about 283 m2/g, and hexane sorption of 39.2 mg/g. The resulting material was then impregnated with platinum (0.3 wt % Pt loading) via incipient wetness using tetraammineplatinum nitrate followed by drying at 250° F. (120° C.) and calcination in full air at 680° F. (360° C.) for 3 hours.

### Example 4: Ni/W Coated ZSM-48/Alumina Extrudate

65 parts by weight (basis: calcined 538° C.) of ZSM-48 crystal were mixed with 35 parts (basis: calcined 538° C.) of pseudoboehmite alumina (Catapal™ 200 commercially available from Sasol Performance Chemicals GmbH) in a Simpson muller. Sufficient water was added to produce an extrudable paste on an extruder. The mix of ZSM-48, pseudoboehmite alumina, and water containing paste was extruded and dried in a hotpack oven at 121° C. overnight. The dried extrudate was calcined in N₂ at 538° C. to decompose and remove the organic template. The N₂-calcined extrudate was humidified with saturated air and exchanged with ammonium nitrate having a Normality of 1 N to remove sodium (spec: <500 ppm Na). After the ammonium nitrate exchange, the extrudate was washed with deionized water to remove residual nitrate ions prior to drying. The ammonium exchanged extrudate was dried at 121° C. overnight and calcined in air at 538° C. After air calcination, the extrudate was steamed for 3 hrs @ 700° F. The H-formed steamed catalysts were then impregnated with Ni and W (˜3 wt % Ni and 15 wt % W). The following properties of the resulting catalyst were determined: alpha value=23; hexane sorption ˜16 mg/g; and surface area ˜130 m²/g.

### Example 5: Pt Coated ZSM-23/Alumina Extrudate

65 parts by weight (basis: calcined 538° C.) of ZSM-23 crystals (having a silica/alumina mole ratio of about 40) prepared according to U.S. Pat. No. 8,500,991 were mixed with 35 parts by weight (basis: calcined 538° C.) of alumina binder in a muller. The mixture of ZSM-23, alumina, and water was extruded to make 1/16″ Quadrulobe extrudate and then dried at 121° C. overnight. The dried extrudate was calcined in N₂ at 538° C. to decompose and remove the organic template. The N₂-calcined extrudate was humidified with saturated air and exchanged with 1 N ammonium nitrate to remove sodium (spec: <500 ppm Na). After the ammonium nitrate exchange, the extrudate was washed with deionized water to remove residual nitrate ions prior to drying. The ammonium exchanged extrudate was dried at 121° C. overnight and calcined in air at 538° C. The H-formed catalyst showed an alpha value of 230, surface area of about 310 m₂/g, and hexane sorption of 44.9 mg/g. The resulting material was then impregnated with platinum (0.3 wt % Pt loading) via incipient wetness using tetraammineplatinum nitrate followed by drying at 250° F. (120° C.) and calcination in full air at 680° F. (360° C.) for 3 hours.

### Example 6: Pt Coated Beta/Alumina Extrudate

A catalyst was made from a mixture of 80 parts by weight (basis: calcined 538° C.) of small Beta crystals with a silica/alumina mole ratio of about 37 and 20 parts by weight (basis: calcined 538° C.) of pseudoboehmite alumina (Versal™ 300) in a muller. Sufficient water was added to produce an extrudable paste on an extruder. The mixture of Beta, pseudoboehmite alumina, and water was extruded into an extrudate and then dried at 121° C. The dried extrudate was calcined in N₂ at 538° C. to decompose and remove the organic template. The N₂-calcined extrudate was humidified with saturated air and exchanged with ammonium nitrate having a Normality of 1 N to remove sodium. After the ammonium nitrate exchange, the extrudate was washed with deionized water to remove residual nitrate ions prior to drying. The ammonium-exchanged extrudate was dried at 121° C. and calcined in air at 538° C. After air calcination, the following properties of the resulting catalyst were determined: alpha value=810; hexane sorption=113 mg/g; and BET surface area (SA)=642 m²/g. The h-formed extrudate was then impregnated with platinum (0.3 wt % Pt loading) via incipient wetness using tetraammineplatinum nitrate followed by drying at 250° F. (120° C.) and calcination in full air at 680° F. (360° C.) for 3 hours.

### Example 7: Pt Coated ZSM-12/Alumina Extrudate

A catalyst was made from a mixture of 65 parts by weight (basis: calcined 538° C.) of small ZSM-12 crystals with a silica/alumina mole ratio of about 45 and 35 parts by weight (basis: calcined 538° C.) of pseudoboehmite alumina (Versal™ 300) in a muller. Sufficient water was added to produce an extrudable paste on an extruder. The mixture of meso-mordenite, pseudoboehmite alumina, and water was extruded into an extrudate and then dried at 121° C. The dried extrudate was calcined in N₂ at 538° C. to decompose and remove the organic template. The N₂-calcined extrudate was humidified with saturated air and exchanged with ammonium nitrate having a Normality of 1 N to remove sodium. After the ammonium nitrate exchange, the extrudate was washed with deionized water to remove residual nitrate ions prior to drying. The ammonium-exchanged extrudate was dried at 121° C. and calcined in air at 538° C. After air calcination, the following properties of the resulting catalyst were determined: alpha value=590; hexane sorption=37.5 mg/g; and BET SA=277 m²/g. The h-formed extrudate was then impregnated with platinum (0.3 wt % Pt loading) via incipient wetness using tetraammineplatinum nitrate followed by drying at 250° F. (120° C.) and calcination in full air at 680° F. (360° C.) for 3 hours.

### Example 8: Pt Coated Mordenite/Alumina Extrudate

A catalyst was made from a mixture of 65 parts by weight (basis: calcined 538° C.) of small meso-Mordenite crystal with a silica/alumina mole ratio of about 21 and 35 parts by weight (basis: calcined 538° C.) of pseudoboehmite alumina (Versal™ 300) in a muller. Sufficient water was added to produce an extrudable paste on an extruder. The mixture of meso-Mordenite, pseudoboehmite alumina, and water was extruded into an extrudate and then dried at 121° C. The dried extrudate was calcined in N₂ at 538° C. to decompose and remove the organic template. The N₂-calcined extrudate was humidified with saturated air and exchanged with ammonium nitrate having a Normality of 1 N to remove sodium. After the ammonium nitrate exchange, the extrudate was washed with deionized water to remove residual nitrate ions prior to drying. The ammonium-exchanged extrudate was dried at 121° C. and calcined in air at 538° C. After air calcination, the following properties of the resulting catalyst were determined: alpha value=500; hexane sorption=53.8 mg/g; and BET SA=479 m²/g. The h-formed extrudate was then impregnated with platinum (0.3 wt % Pt loading) via incipient wetness using tetraammineplatinum nitrate followed by drying at 250° F. (120° C.) and calcination in full air at 680° F. (360° C.) for 3 hours.

### Example 9: Pt Coated USY/Alumina Extrudate

A catalyst was made from a mixture of 80 parts by weight (basis: calcined 538° C.) of ammonium-formed USY zeolite crystals (Tosoh HSZ-350HUA commercially available from Tosoh Corp.) with a silica/alumina mole ratio of about 10.2 and 20 parts by weight (basis: calcined 538° C.) of pseudoboehmite alumina (Versal™ 300) in a muller. Sufficient water was added to produce an extrudable paste on an extruder. The mixture of USY, pseudoboehmite alumina, and water was extruded into an extrudate, and then dried at 121° C. The green extrudate was dried at 121° C. and calcined in air at 538° C. After air calcination, the following properties of the resulting catalyst were determined: alpha value=370; hexane sorption=121.2 mg/g; and BET SA=816 m²/g. The h-formed calcined extrudate was then impregnated with platinum (0.3 wt % Pt loading) via incipient wetness using tetraammineplatinum nitrate followed by drying at 250° F. (120° C.) and calcination in full air at 680° F. (360° C.) for 3 hours.

### Example 10: Pt Coated MCM-49/Alumina Extrudate

A catalyst was made from a mixture of 80 parts by weight (basis: calcined 538° C.) of MCM-49 crystal and 20 parts by weight (basis: calcined 538° C.) of high surface area alumina (Versal™ 300) in a muller. The mixture of MCM-49, alumina, and water was extruded into extrudates and then dried in a hotpack oven at 121° C. overnight. The dried extrudate was calcined in N₂ at 538° C. to decompose and remove the organic template. The N₂-calcined extrudate was humidified with saturated air and exchanged with ammonium nitrate having a Normality of 1 N to remove sodium. After the ammonium nitrate exchange, the extrudate was washed with deionized water to remove residual nitrate ions prior to drying. The ammonium-exchanged extrudate was dried at 121° C. overnight and calcined in air at 538° C. After air calcination, the following properties of the resulting H-formed extrudate were determined: alpha value=520; hexane sorption ˜91 mg/g; and BET surface area=536 m²/g. The H-formed calcined extrudate was then impregnated with platinum (0.3 wt % Pt loading) via incipient wetness using tetraammineplatinum nitrate followed by drying at 250° F. (120° C.) and calcination in full air at 680° F. (360° C.) for 3 hours.

### Example 11: Pt Coated SO₄-Doped Silica-Alumina Hydrate Extrudate

A SO₄-doped self-bound silica-alumina hydrate extrudate catalyst exhibiting a high collidine uptake was prepared in accordance with the following procedure. First, a sample of Siral™-20 amorphous silica-alumina hydrate in powder form (commercially available from Sasol Performance Chemicals GmbH) was mulled. Water was added to the mulled silica-alumina hydrate in an amount sufficient to produce an extrudable paste, after which the resulting paste was extruded into 1/16 in (0.16 cm) quadrulobe extrudates. The prepared extrudates were dried at 120° C. for 3 hours and subsequently calcined in air at 500° C. for 3 hours. The calcined extrudates were then impregnated with a desired amount of ammonium sulfate solution, dried, and subsequently calcined in air at 538° C. for 3 hours. The final catalyst composition exhibited a sulfur content of 1.49 wt % and a collidine uptake of 253 μmol/g. The calcined material was then impregnated with platinum (0.3 wt % Pt loading) via incipient wetness using tetraammineplatinum nitrate followed by drying at 250° F. (120° C.) and calcination in full air at 680° F. (360° C.) for 3 hours.

### Example 12: Pt Coated MCM-41/Alumina Extrudate

A1-MCM-41 crystals prepared in accordance with the methods of U.S. Pat. No. 7,538,065 (which is incorporated by reference herein) and having 30 Å pores and a silica/alumina mole ratio of about 25 were used to prepare a 65 wt % MCM-41/35 wt % alumina particle in accordance with the following procedure. First, 65 parts by weight (basis: calcined 538° C.) of the A1-MCM-41 crystals were mulled with 35 parts by weight (basis: calcined 538° C.) of pseudoboehmite alumina (Versal™-300). Deionized water was added to the mull mixture in an amount sufficient to produce an extrudable paste, after which the mull mixture was extruded into 1/16 in (0.16 cm) quadrulobe extrudates. The prepared extrudates were dried at 120° C. for 3 hours and subsequently calcined in air at 540° C. for 3 hours. The final catalyst composition exhibited a hexane sorption of 59.7 mg/g, surface area of 814 m²/g, and a collidine uptake of 260 μmol/g. The calcined extrudates were then impregnated with platinum (0.3 wt % Pt loading) via incipient wetness using tetraammineplatinum nitrate followed by drying at 250° F. (120° C.) and calcination in full air at 680° F. (360° C.) for 3 hours.

In the foregoing examples, the alpha values and collidine uptake amounts were determined as described in the Detailed Description. The total BET and the t-Plot micropore surface areas were measured by nitrogen adsorption/desorption with a Micromeritics Tristar II 3020 instrument after degassing of the calcined zeolite powders for 4 hrs at 350 C. The mesopore surface area was obtained by the subtraction of the t-plot micropore from the total BET surface area. The mesopore volume was derived from the same data set. More information regarding the method can be found, for example, in “Characterization of Porous Solids and Powders: Surface Area, Pore Size and Density”, S. Lowell et al., Springer, 2004.

The X-ray diffraction data (powder XRD or XRD) were collected with a Bruker D4 Endeavor diffraction system with a VANTEC multichannel detector using copper K-alpha radiation. The diffraction data were recorded by scanning mode with 0.018 degrees two-theta, where theta is the Bragg angle, and using an effective counting time of about 30 seconds for each step.

The crystal sizes in the a, b and c crystal vectors were calculated based on the three (200), (020) and (002) peaks in the X-ray diffraction patterns using the Scherrer equation (P. Scherrer, N. G. W. Gottingen, Math-Pys., 2, p. 96-100 (1918)). The method and its application to zeolites are also described in A. W. Burton, K. Ong, T. Rea, I. Y. Chan, Microporous and Mesoporous Materials, 117, p. 75-90 (2009). For the measurements described herein, the Jade version 9.5.1 X-ray diffraction analysis software by Materials Data, Inc., was used to perform the calculation.

The catalyst prepared in Ex.1 (Pt/ZSM-48) or Ex.2 (Pt/ZSM-23) was used to isomerize/hydrogenate unsaturated PAO in a continuous, isothermal, tubular fixed bed reactor for seven different runs (Runs 1-7). Each catalyst was loaded into the reactor in the amount specified in Table 1, along with approximately 15 to 20 g of silicon carbide (SiC). The catalyst was loaded between two separate sections of SiC such that it was securely positioned in the isothermal zone of the reactor. The reactor with the dry catalyst bed was first heated to 150° C. at 10° C./min ramp rate under 250 sccm N₂ at ambient pressure for 0.5 hours, then switched to H₂ flow at 250 sccm and ramped to 300° C. for 3 hours at ambient pressure, and then reduced to a temperature of 150° C. After reaching the desired temperature, the H₂ flow and the pressure were changed to the desired level specified in Table 1 below, and the liquid feed (a batch of unsaturated PAO feed obtained internally from metallocene catalyzed oligomerization of C₈-C₁₂ LAOs was fed at 2 h⁻¹. Once the liquid feed reached the product knock out, the liquid flow rate was changed to the desired reaction flow rate (Liquid Hourly Space Velocity (LHSV)) specified in Table 1 below, and the temperature was increased to the desired reaction temperature (see Table 1 below) at 10° C./min. The crude product collected from the reactor was then distilled at 165° C. at 1.5-2.5 torr to remove any possible light materials generated to obtain the finished saturated PAO product.

Table 1 below summarizes the catalyst used and the reaction conditions for Runs 1-7, as well as analysis of the resulting saturated isomerized PAO product. The properties of a finished saturated PAO product produced via standard hydrogenation with a Ni/Al₂O₃ catalyst (Comparative Example 1) was also included for comparison. The kinematic viscosity at 100° C. (KV100) and the kinematic viscosity at 40° C. (KV40) were determined according to ASTM D-445. The viscosity index was determined according to ASTM D2270. Pour point (PP) was determined according to ASTM D5950. Bromine number (Br #), which is a measurement of the remaining unsaturated double bonds in the PAO product, was determined by measuring g Br per 100 g of product sample.

TABLE 1
Process Conditions and Properties of Isomerized/Hydrogenated PAO

| | | | H₂ | | | | | | | |
|---|---|---|---|---|---|---|---|---|---|---|
| | | Temp. | flow | Press | LHSV | KV100 | KV40 | | PP | Br# |
| Run | Cat. | (° C.) | (sccm) | (psig) | (h⁻¹) | (cSt) | (cSt) | VI | (° C.) | (gBr/100 g) |
| | C. Ex. 1 | — | — | — | — | 3.849 | 16.21 | 133.0 | −69 | 0.19 |
| 1 | Ex. 2 | 255 | 18 | 100 | 3.0 | 3.781 | 16.17 | 126.0 | −75 | 0.24 |
| 2 | Ex. 2 | 235 | 18 | 100 | 3.0 | 3.764 | 15.96 | 127.0 | −75 | 0.11 |
| 3 | Ex. 2 | 215 | 18 | 100 | 3.0 | 3.723 | 15.62 | 128.6 | −69 | 0 |
| 4 | Ex. 2 | 205 | 18 | 100 | 3.0 | 3.715 | 15.49 | 130.0 | −69 | 0.07 |
| 5 | Ex. 2 | 275 | 18 | 100 | 3.0 | 3.745 | 16.02 | 123.9 | −78 | 0.04 |
| 6 | Ex. 2 | 275 | 18 | 100 | 4.5 | 3.717 | 15.93 | 122.1 | −78 | 0 |
| 7 | Ex. 1 | 265 | 18 | 100 | 3.0 | 3.807 | 16.32 | 126.0 | −75 | 0 |

It was surprisingly found that the finalized PAO products of runs 1-2 and 5-6 exhibited a 6° C. to 9° C. drop in pour point compared to the PAO product produced using the catalyst of C.Ex.1. This drop in pour point demonstrates better isomerization of the PAO products in runs 1-2 and 5-6. All of the PAO products showed a decrease in bromine number from a theoretical 35 down to below 1, indicating that the PAO products had undergone complete hydrogenation.

### Listing of Embodiments

This disclosure may further include any one or more of the following non-limiting embodiments:

1. A process for making a saturated isomerized polyalphaolefin, comprising: contacting at least one unsaturated polyalphaolefin with a catalyst capable of both isomerizing and hydrogenating the at least one unsaturated polyalphaolefin to form at least one saturated isomerized polyalphaolefin, wherein the catalyst comprises a zeolite or a mesoporous material, the zeolite having a silica to alumina mole ratio of from about 5 to about 100 and an alpha value of from about 10 to about 1,000, and the mesoporous material having a collidine uptake of from about 100 μmoles/g to about 500 μmoles/g, wherein a Group VIB to VIIIB metal is incorporated in the catalyst at a concentration of from about 0.01 wt % to about 60.00 wt %, based on a total weight of the catalyst, and wherein the zeolite is selected from the group consisting of ZSM-48, ZSM-23, ZSM-12, ZSM-35, ZSM-11, ZSM-57, Beta zeolite, Mordenite zeolite, USY zeolite, zeolite having an MWW framework, and combinations thereof.

2. The process according to embodiment 1, wherein the zeolite comprises ZSM-48 having a silica to alumina mole ratio of from about 50 to about 90, ZSM-23 having a silica to alumina mole ratio of from about 30 to about 60, or combinations hereof.

3. The process according to embodiment 1 or 2, wherein the at least one unsaturated polyalphaolefin comprises low viscosity polyalphaolefin having a kinematic viscosity of from about 2 cSt to about 10 cSt at 100° C., according to ASTM D-445.

4. The process according to any embodiment 1 to 3, wherein the at least one unsaturated polyalphaolefin comprises high viscosity polyalphaolefin having a kinematic viscosity of from about 20 cSt to about 300 cSt at 100° C., according to ASTM D-445.

5. The process according to any embodiment 1 to 4, wherein the zeolite comprises a pore size of from about 5.0 Å to about 7.5 Å.

6. The process according to any embodiment 1 to 5, wherein the zeolite comprises an alpha value of from about 20 to about 600.

7. The process according to any embodiment 1 to 6, wherein the ZSM-12, the Beta zeolite, the Mordenite, the USY zeolite, and the zeolite having the MWW framework have a silica to alumina mole ratio of from about 10 to about 60, wherein the ZSM-35 and the ZSM-11 have a silica to alumina mole ratio of from about 20 to about 60, and wherein the ZSM-57 has a silica to alumina mole ratio of from about 40 to about 60.

8. The process according to any embodiment 1 to 7, wherein the mesoporous material comprises amorphous alumina, amorphous silica, amorphous silica-alumina, amorphous silica-titania, MCM-41, or combinations thereof.

9. The process according to embodiment 8, wherein the amorphous alumina, the amorphous silica, the amorphous silica-alumina, or the amorphous silica-titania comprises a dopant selected from the group consisting of sulfate, zirconium, lanthanum, magnesium, thorium, beryllium, titanium, and combinations thereof, and wherein the dopant content is from about 0.1 wt % to about 20 wt %.

10. The process according to any embodiment 1 to 9, wherein the mesoporous material has a collidine uptake of from about 150 μmoles/g to about 500 μmoles/g.

11. The process according to any embodiment 1 to 10, wherein the catalyst comprises a binder combined with the zeolite or the mesoporous material, wherein the binder comprises clay, silica, alumina, zirconia, titania, silica-alumina, silica-magnesia, silica-zirconia, silica-thoria, silica-beryllia, silica-titania, or combinations thereof., and wherein the binder content in the catalyst is from about 10 wt % to about 80 wt %.

12. The process according to any embodiment 1 to 11, wherein the Group VIB to VIIIB metal comprises Pt, Pd, or a combination thereof, and wherein the Group VIB to VIIIB metal content is from about 0.01 wt % to about 10.00 wt %.

13. The process according to any embodiment 1 to 12, wherein the Group VIB to VIIIB metal comprises Co, Ni, W, Mo, or a combination thereof, and wherein the Group VIB to VIIIB metal content is from about 0.05 wt % to about 60.00 wt %.

14. The process according to any embodiment 1 to 13, wherein said contacting the at least one unsaturated polyalphaolefin with the catalyst is performed in a single reactor at a temperature of from about 150° C. to about 500° C. and a pressure of from about 345 kPa absolute to about 6,895 kPa absolute, and in the presence of H2 at a concentration of from about 0.1 wt % to about 3.0 wt %, based on a total weight of the at least one unsaturated polyolefin.

15. The process according to any embodiment 1 to 14, wherein said contacting the at least one unsaturated polyalphaolefin with the catalyst is performed in a single reactor at a temperature of from about 220° C. to about 300° C. and a pressure of from about 1,034 kPa to about 6,895 kPa, and in the presence of H2 at a concentration of from about 0.1 wt % to about 3.0 wt %, based on a total weight of the at least one unsaturated polyolefin.

16. A process for making a saturated isomerized polyalphaolefin, comprising: contacting at least one unsaturated polyalphaolefin with a catalyst capable of both isomerizing and hydrogenating the at least one unsaturated polyalphaolefin to make at least one saturated isomerized polyalphaolefin, wherein the catalyst comprises a zeolite selected from the group consisting of ZSM-48, ZSM-23, and combinations thereof, the zeolite having a silica to alumina mole ratio of from about 20 to about 100 and an alpha value of from about 50 to about 600, and wherein a Group VIB to VIIIB metal is incorporated in the catalyst at a concentration of from about 0.01 wt % to about 60.00 wt %, based on a total weight of the catalyst.

17. The process of according to embodiment 16, wherein the at least one unsaturated polyalphaolefin comprises low viscosity polyalphaolefin having a kinematic viscosity of from about 2 cSt to about 10 cSt at 100° C., according to ASTM D-445, and wherein the at least one saturated isomerized polyalphaolefin that is made comprises a bromine number of less than about 0.50 g Br/100 g of a sample of the at least one saturated isomerized polyalphaolefin and a pour point of greater than about −99 and less than about −45, according to ASTM D5950.

18. The process according to embodiment 16 or 17, wherein the at least one unsaturated polyalphaolefin comprises high viscosity polyalphaolefin having a kinematic viscosity of from about 20 cSt to about 300 cSt at 100° C., according to ASTM D-445, and wherein the at least one saturated isomerized polyalphaolefin that is made comprises a bromine number of less than about 2.0 g Br/100 g of a sample of the at least one saturated isomerized polyalphaolefin and a pour point of greater than about −51° C. and less than about −30° C., according to ASTM D5950.

19. The process according to any embodiment 16 to 18, wherein the zeolite comprises a pore size of from about 4.5 Å to about 5.5 Å.

20. The process according to any embodiment 16 to 19, wherein the ZSM-48 has a silica to alumina mole ratio of from about 50 to about 90, and wherein the ZSM-23 has a silica to alumina mole ratio of from about 30 to about 60.

21. The according to any embodiment 16 to 20, wherein the Group VIB to VIIIB metal comprises Pt, Pd, or a combination thereof, and wherein the Group VIB to VIIIB metal content is from about 0.01 wt % to about 10.00 wt %.

22. The process according to any embodiment 16 to 21, wherein the Group VIB to VIIIB metal comprises Co, Ni, W, Mo, or a combination thereof, and wherein the Group VIB to VIIIB metal content is from about 0.05 wt % to about 60.00 wt %.

23. The process according to any embodiment 16 to 22, wherein said contacting the at least one unsaturated polyalphaolefin with the catalyst is performed in a single reactor at a temperature of from about 150° C. to about 500° C. and a pressure of from about 345 kPa absolute to about 6 6,895 kPa absolute, and in the presence of H2 at a concentration of from about 0.1 wt % to about 3.0 wt %, based on a total weight of the at least one unsaturated polyolefin.

24. The process according to any embodiment 16 to 23, wherein said contacting the at least one unsaturated polyalphaolefin with the catalyst is performed in a single reactor at a temperature of from about 220° C. to about 300° C. and a pressure of from about 1,034 kPa to about 6 6,895 kPa, and in the presence of H2 at a concentration of from about 0.1 wt % to about 3.0 wt %, based on a total weight of the at least one unsaturated polyolefin.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A process for making a saturated isomerized polyalphaolefin, comprising:
contacting at least one unsaturated polyalphaolefin with a catalyst capable of both isomerizing and hydrogenating the at least one unsaturated polyalphaolefin to form at least one saturated isomerized polyalphaolefin, wherein the catalyst comprises a zeolite or a mesoporous material, the zeolite having a silica to alumina mole ratio of from about 5 to about 100 and an alpha value of from about 10 to about 1,000, and the mesoporous material having a collidine uptake of from about 100 μmoles/g to about 500 μmoles/g, wherein a Group VIB to VIIIB metal is incorporated in the catalyst at a concentration of from about 0.01 wt % to about 60.00 wt %, based on a total weight of the catalyst, and wherein the zeolite is selected from the group consisting of ZSM-48, ZSM-23, ZSM-12, ZSM-35, ZSM-11, ZSM-57, Beta zeolite, Mordenite zeolite, USY zeolite, zeolite having an MWW framework, and combinations thereof.

2. The process of claim 1, wherein the zeolite comprises ZSM-48 having a silica to alumina mole ratio of from about 50 to about 100, ZSM-23 having a silica to alumina mole ratio of from about 30 to about 60, or combinations hereof.

3. The process of claim 1, wherein the at least one unsaturated polyalphaolefin comprises low viscosity polyalphaolefin having a kinematic viscosity of from about 2 cSt to about 10 cSt at 100° C., according to ASTM D-445.

4. The process of claim 1, wherein the at least one unsaturated polyalphaolefin comprises high viscosity polyalphaolefin having a kinematic viscosity of from about 20 cSt to about 300 cSt at 100° C., according to ASTM D-445.

5. The process of claim 1, wherein the zeolite comprises a pore size of from about 5.0 Å to about 7.5 Å.

6. The process of claim 1, wherein the zeolite comprises an alpha value of from about 20 to about 600.

7. The process of claim 1, wherein the ZSM-12, the Beta zeolite, the Mordenite, the USY zeolite, and the zeolite having the MWW framework have a silica to alumina mole ratio of from about 10 to about 60, wherein the ZSM-35 and the ZSM-11 have a silica to alumina mole ratio of from about 20 to about 60, and wherein the ZSM-57 has a silica to alumina mole ratio of from about 30 to about 60.

8. The process of claim 1, wherein the mesoporous material comprises amorphous alumina, amorphous silica, amorphous silica-alumina, amorphous silica-titania, MCM-41, or combinations thereof.

9. The process of claim 8, wherein the amorphous alumina, the amorphous silica, the amorphous silica-alumina, or the amorphous silica-titania comprises a dopant selected from the group consisting of sulfate, zirconium, lanthanum, magnesium, thorium, beryllium, titanium, and combinations thereof, and wherein the dopant content is from about 0.1 wt % to about 20 wt %.

10. The process of claim 1, wherein the mesoporous material has a collidine uptake of from about 150 μmoles/g to about 500 μmoles/g.

11. The process of claim 1, wherein the catalyst comprises a binder combined with the zeolite or the mesoporous material, wherein the binder comprises clay, silica, alumina, zirconia, titania, silica-alumina, silica-magnesia, silica-zirconia, silica-thoria, silica-beryllia, silica-titania, or combinations thereof, and wherein the binder content in the catalyst is from about 10 wt % to about 80 wt %.

12. The process of claim 1, wherein the Group VIB to VIIIB metal comprises Pt, Pd, or a combination thereof, and wherein the Group VIB to VIIIB metal content is from about 0.01 wt % to about 10.00 wt %.

13. The process of claim 1, wherein the Group VIB to VIIIB metal comprises Co, Ni, W, Mo, or a combination thereof, and wherein the Group VIB to VIIIB metal content is from about 0.05 wt % to about 60.00 wt %.

14. The process of claim 1, wherein said contacting the at least one unsaturated polyalphaolefin with the catalyst is performed in a single reactor at a temperature of from about 150° C. to about 500° C. and a pressure of from about 345 kPa absolute to about 6,895 kPa absolute, and in the presence of H₂ at a concentration of from about 0.1 wt % to about 3.0 wt %, based on a total weight of the at least one unsaturated polyolefin.

15. The process of claim 1, wherein said contacting the at least one unsaturated polyalphaolefin with the catalyst is performed in a single reactor at a temperature of from about 220° C. to about 300° C. and a pressure of from about 1,034 kPa to about 6,895 kPa, and in the presence of H₂ at a concentration of from about 0.1 wt % to about 3.0 wt %, based on a total weight of the at least one unsaturated polyolefin.

16. A process for making a saturated isomerized polyalphaolefin, comprising:
contacting at least one unsaturated polyalphaolefin with a catalyst capable of both isomerizing and hydrogenating the at least one unsaturated polyalphaolefin to make at least one saturated isomerized polyalphaolefin, wherein the catalyst comprises a zeolite selected from the group consisting of ZSM-48, ZSM-23, and combinations thereof, the zeolite having a silica to alumina mole ratio of from about 20 to about 100 and an alpha value of from about 50 to about 600, and wherein a Group VIB to VIIIB metal is incorporated in the catalyst at a concentration of from about 0.01 wt % to about 60.00 wt %, based on a total weight of the catalyst.

17. The process of claim 16, wherein the at least one unsaturated polyalphaolefin comprises low viscosity polyalphaolefin having a kinematic viscosity of from about 2 cSt to about 10 cSt at 100° C., according to ASTM D-445, and wherein the at least one saturated isomerized polyalphaolefin that is made comprises a bromine number of less than about 0.50 g Br/100 g of a sample of the at least one saturated isomerized polyalphaolefin and a pour point of greater than about −99° C. and less than about −45° C., according to ASTM D5950.

18. The process of claim 16, wherein the at least one unsaturated polyalphaolefin comprises high viscosity polyalphaolefin having a kinematic viscosity of from about 20 cSt to about 300 cSt at 100° C., according to ASTM D-445, and wherein the at least one saturated isomerized polyalphaolefin that is made comprises a bromine number of less than about 2.0 g Br/100 g of a sample of the at least one saturated isomerized polyalphaolefin and a pour point of greater than about −51° C. and less than about −30° C., according to ASTM D5950.

19. The process of claim 16, wherein the zeolite comprises a pore size of from about 4.5 Å to about 5.5 Å.

20. The process of claim 16, wherein the ZSM-48 has a silica to alumina mole ratio of from about 50 to about 100, and wherein the ZSM-23 has a silica to alumina mole ratio of from about 30 to about 60.

21. The process of claim 16, wherein the Group VIB to VIIIB metal comprises Pt, Pd, or a combination thereof, and wherein the Group VIB to VIIIB metal content is from about 0.01 wt % to about 10.00 wt %.

22. The process of claim 16, wherein the Group VIB to VIIIB metal comprises Co, Ni, W, Mo, or a combination thereof, and wherein the Group VIB to VIIIB metal content is from about 0.05 wt % to about 60.00 wt %.

23. The process of claim 16, wherein said contacting the at least one unsaturated polyalphaolefin with the catalyst is performed in a single reactor at a temperature of from about 150° C. to about 500° C. and a pressure of from about 345 kPa absolute to about 6 6,895 kPa absolute, and in the presence of H₂ at a concentration of from about 0.1 wt % to about 3.0 wt %, based on a total weight of the at least one unsaturated polyolefin.

24. The process of claim 16, wherein said contacting the at least one unsaturated polyalphaolefin with the catalyst is performed in a single reactor at a temperature of from about 220° C. to about 300° C. and a pressure of from about 1,034 kPa to about 6 6,895 kPa, and in the presence of H₂ at a concentration of from about 0.1 wt % to about 3.0 wt %, based on a total weight of the at least one unsaturated polyolefin.
